(19) United States
(12) Patent Application Publication
(10) Pub. No.: US 2017/0320171 A1
(43) Pub. Date: Nov. 9, 2017

(54) PALLIATIVE SUPERALLOY WELDING PROCESS

(71) Applicant: SIEMENS ENERGY, INC., Orlando, FL (US)

(72) Inventors: THADDEUS STRUSINSKI, PFAFFTOWN, NC (US); GERALD J. LYNCH, WINSTON-SALEM, NC (US); MATTHEW H. LANG, ORLANDO, FL (US)

(21) Appl. No.: 15/495,005

(22) Filed: Apr. 24, 2017

Related U.S. Application Data
(60) Provisional application No. 62/332,561, filed on May 6, 2016.

(51) Int. Cl. B23K 35/36; B23K 26/24; B23K 26/211; B23K 26/12; B23K 35/362; B23K 26/32

(52) U.S. Cl. CPC B23K 35/3606; B23K 35/362; B23K 26/32; B23K 26/211; B23K 26/123; B23K 26/24

(57) ABSTRACT

A method of welding including: applying a flux having at least a majority weight percent boron to a surface of a superalloy base material; forming a weldment on the surface wherein boron is melted onto the surface and is incorporated into a resulting weld pool and heat affected zone, and wherein incipient melted inter-dendritic material resulting from presence of the boron is available to flow into a crack formed during cooling of the weldment; and heat treating the weldment to diffuse a remaining concentration of the boron in the weldment and heat affected zone to a desired value.

### CROSS-REFERENCE TO RELATED APPLICATIONS

This application claims the benefit of U.S. Provisional Patent Application No. 62/332,561 filed May 6, 2016, the disclosure of which is hereby incorporated by reference herein.

### FIELD OF THE INVENTION

The invention relates to a method of welding of superalloys that heals weld-induced cracks.

### BACKGROUND OF THE INVENTION

Highly alloyed nickel and cobalt castings (e.g. CM-247 LC®, Inconel®-738, GTD-111™, MGA-1400, ECY-768, MAR-M 509® etc.) are commonly used in gas turbine engine hot gas path applications. Alloying elements (e.g. Al, W, C, Ti, Ta) used in the castings increase the difficulty of achieving good castings and reduce the weldability of components made of the castings. In particular, the presence of these alloying elements may lead to cracking in the weld and heat affected zone (HAZ) of the casting when welded. However, welding can be a necessary part of fabrication and/or repair of these components. To achieve crack free weldments, one approach has been to use relatively ductile weld fillers (e.g. Inconel®-625, Haynes®-230®, Haynes®-188, Nimonie-263, Inconel®-617, Merl-72, Waspaloy®, etc.). These fillers have a reduced mechanical strength and oxidation resistance compared to the nickel and cobalt castings (i.e. base metals) where operating temperatures exceed 1800 degrees Fahrenheit. Consequently, these ductile weld fillers cannot be used in some applications.

It is known to use boron as a melting point suppressant in welding. U.S. Pat. No. 2,507,751 to Bennett discloses using a slag-forming flux containing a minority amount of boron for improved wetting action and lowered surface tension. Bennett cautions against using too high of a percentage of boron. United States Patent Application Publication No. US 2015/0298263 A1 to Goncharov, et al. discloses a welding wire having a coating containing less than 10% boron and silicon. Blacksmiths have been known to take steel up to orange color, apply boron, take the steel up to yellow color, and tap the steel onto itself to incorporate the boron. However, in that process no material is melted and the boron is understood to act on the base metal as a whole.

There remains room in the art for improvement with respect to welding high alloy materials such as modern superalloys.

### BRIEF DESCRIPTION OF THE DRAWINGS

The invention is explained in the following description in view of the drawings that show:

FIG. 1 is a schematic representation of the welding process disclosed herein.

FIG. 2 is a schematic representation of dendritic grain structure with an inter-dendritic region before boron infusion.

FIG. 3 is a schematic representation of the dendritic grain structure with an inter-dendritic region of FIG. 2 after boron infusion and showing incipient melting.

FIG. 4 is a schematic representation of the dendritic grain structure with an inter-dendritic region of FIG. 3 showing crack formation and the crack healing process.

FIG. 5 is a schematic representation of the dendritic grain structure with an inter-dendritic region of FIG. 4 showing healed cracks.

### DETAILED DESCRIPTION OF THE INVENTION

The present inventors have devised a unique method of welding a nickel, cobalt, or iron based superalloy that enables the use of a base material equivalent weld filler material with reduced cracking. As used herein a base material equivalent is one recognized by those of ordinary skill in the art as having the same or essentially the same chemical composition as a base material. The method includes applying essentially pure boron to a cast superalloy component proximate the location where the weld is to be formed, and then forming the weld. The boron melts in advance of the moving weld pool and functions to shield the heated, but still solid, material. Boron is then incorporated into the weld pool and also diffuses into the heat affected zone (HAZ) of the cast superalloy component. The boron lowers the melting point of material in interdendritic zones of the cast superalloy component, which contributes to incipient melting in the interdendritic zones. If a crack forms, incipiently melted material in the interdendritic zone can flow into the crack, thereby healing the crack. The flow of incipiently melted material may be aided by a vacuum created within the crack as a result of the crack formation which draws the incipiently melted material into the crack. The lower melting point of some material in the weld pool allows the lower melting temperature material to flow more readily throughout higher melting temperature material as the higher melting material solidifies and changes volume. This provides a degree of conformity as the weld cools and solidifies, thereby reducing crack formation in the weld as well.

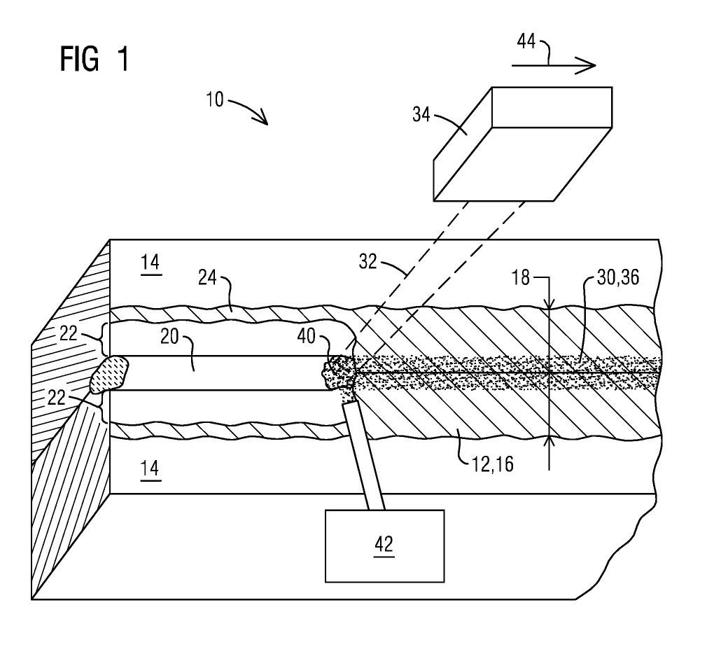

FIG. 1 is a schematic representation of an exemplary embodiment of the welding process disclosed herein. An incipient melt facilitator 16 in the form of a flux paste 12 is preplaced directly on a superalloy substrate 14. The paste 12 may be applied by any number of methods, including but not limited to simply brushing the paste 12 on the component 10. The paste may be applied to in a thickness, e.g., in the range of (0.005″-0.020″). The paste 12 includes an incipient melt facilitator 16 that locally reduces a melting temperature of at least a portion of the superalloy substrate 14. This reduces the amount of heat that must be input during the process, which reduces heat related problems such as distortion and cracking, etc. An example of such an incipient melt facilitator 16 is boron, and the paste 12 may include boron and a carrier such as alcohol. The boron may be amorphous or it may have an identifiable crystal shape. The boron may be anhydrous or it may include water. Unlike prior art welding fluxes typically used for superalloy materials, the paste may be composed of greater than 50% by weight of boron, or greater than 75% or 90% or 99% by weight boron in various embodiments. In an exemplary embodiment, the paste may be borax or any allotrope of boron. The borax may include Na₂B₄O₇ with or without water. The paste 12 may be spread to any width 18 about the weld joint line. In an exemplary embodiment, the width 18 may be sufficient to cover a weld bead 20 and a heat affected zone 22 with overage 24 extending past the heat affected zone 22 to ensure adequate coverage. However, the width 18 may also be narrower.

The weld bead 20 may be formed by heating the substrate 14 and a weld filler material 30 via an energy beam 32 generated by an energy beam source 34. The substrate 14 may be a nickel, cobalt, or iron based superalloy. The weld filler material 30 may be a filler powder 36 that is preplaced on, under, or mixed in with the paste 12. Alternately, or in addition, the weld filler material 30 may be delivered directly to a melt pool 40 via a delivery arrangement 42. The weld filler material 30 may be solid, for example, in rod form.

The weld filler material 30 may be a material that has the same composition as the superalloy of the substrate 14, or a similar composition which after welding forms a base material equivalent weld deposit 20. Alternately, the weld filler material 30 may include a material that is superior to the superalloy of the substrate 14 in some desired functionality but that otherwise has been found to be difficult to deposit without cracking prior to the present invention. Alternately, the welding process may use no weld filler material 30 (e.g. autogenous). The energy beam may be a laser beam or an electron beam, although other methods of heat delivery may be used, with or without preheating. The process may occur under the protection of a shielding gas, such as an inert shielding gas. Alternately, the weld may instead be formed via other processes such as gas tungsten arc welding (GTAW), shielded metal arc welding (SMAW), metal inert gas (MIG), metal active gas (MAG), plasma arc welding (PAW), submerged arc welding (SAW), friction stir welding, and their derivatives.

In the process of FIG. 1, as the melt pool 40 moves in a direction of travel 44, some or all of the paste 12 is consumed. The paste 12 may become molten ahead of the melt pool 40, which may provide additional atmospheric protection to the heat affected zone 22. Some of the incipient melt facilitator 16 (e.g. boron) in the paste 12 is incorporated into the melt pool 40, and some of the incorporated incipient melt facilitator 16 diffuses into the heat affected zone 22. Incipient melt facilitator 16 in the paste atop the heat affected zone 22 may diffuse directly into the component 10. The incipient melt facilitator 16 that has diffused into the heat affected zone 22 suppresses a melting temperature of at least one part of the material of the heat affected zone 22 such that some of the material in the heat affected zone 22 experiences incipient melting. Any cracks or fissures that form in an unmelted portion of the heat affected zone 22 during cooling may be filled (e.g. healed) by the incipiently melted material in the heat affected zone 22 that can flow into the crack. Likewise, relatively low melting temperature material in the melt pool 40 can conform to previously solidified material as the weld bead 20 solidifies and takes shape, thereby reducing cracking in the weld bead 20.

A welding process using superalloy filler material and flux material is disclosed in United States Patent Application Publication No. 2013/0136868 A1 to Bruck et al., and is incorporated herein by reference. The present invention may be used with such a welding process to weld a superalloy using powdered superalloy weld filler material, powdered flux material, and the incipient melt facilitator 16 disclosed herein. These materials may be applied in discrete layers in any order, or some or all of them may be blended as desired. It should be appreciated that weld parameters for reduced heat input welding enabled by boron may include, e.g., a filler metal diameter of (0.035″-0.092″), Current Type & Polarity (DC Straight-AC), Amps (5-210), and a travel speed of (½Inch/min-20 inch/min).

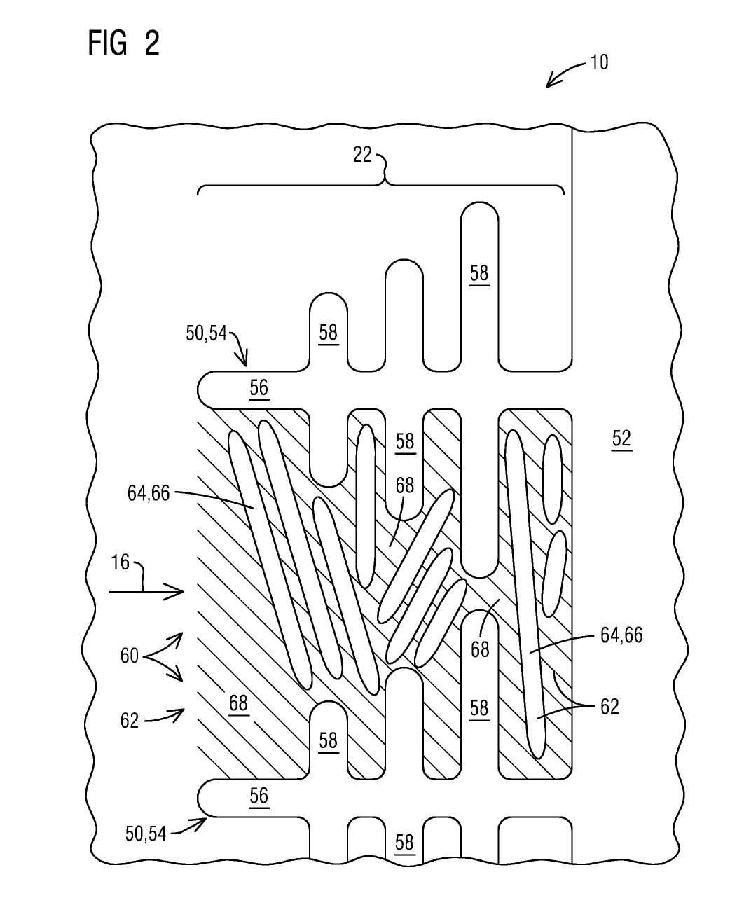

With continued reference to the figures, FIG. 2 shows a dendritic structure 50 of a crystal 52 of the superalloy component 10 in the heat affected zone 22. Each dendrite 54 includes a trunk 56 and branches 58. An interdendritic region 60 exists between the dendrites 54 and includes segregates 62 of different alloying elements (e.g. Ti and Al). This includes gamma prime (γ′) phases with different chemical compositions at various regions within the microstructure, which leads to different melting temperatures. In addition, most superalloys include other phases such as gamma-gamma prime (γ-γ′) eutectics, MC carbides (where M represents one or more metallic atoms), topologically closely packed (TCP) phases, eta (η) phase, and borides. Variations of any of these may vary the local melting temperature, and areas with relatively low melting temperatures may experience the incipient melting described herein.

The segregates 62 may include the eta (η) phase 64 in the form of plates 66 and other segregates 68 in between the plates 66. In the exemplary embodiment the incipient melt facilitator 16 is boron, and in FIG. 2 the boron 16 is illustrated as being at the beginning stages of its diffusion process into the interdendritic region 60 in the heat affected zone 22. As the boron diffuses, it reaches the regions of differing chemical composition and suppresses respective melting temperatures further, thereby promoting incipient melting.

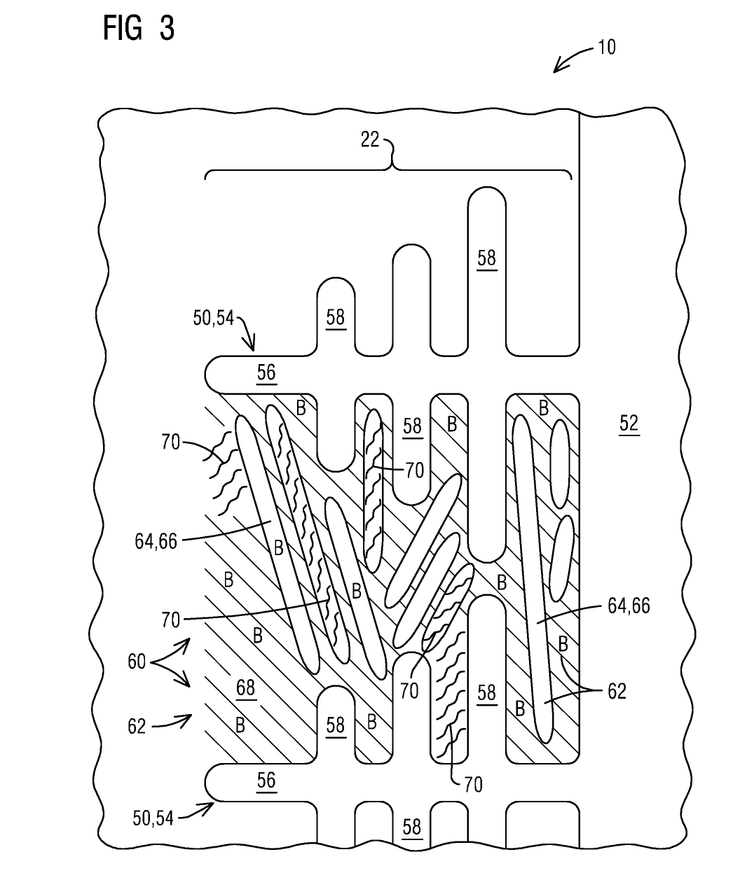

FIG. 3 shows the boron diffused into the interdendritic region 60 of the heat affected zone during the welding process as indicated by the letter “B.” The boron has suppressed the melting temperature locally and incipient melting has occurred, creating incipiently melted material 70 in the interdendritic region 60 as indicated by the wavy lines. In this exemplary embodiment, the dendritic structure 50 remains solid.

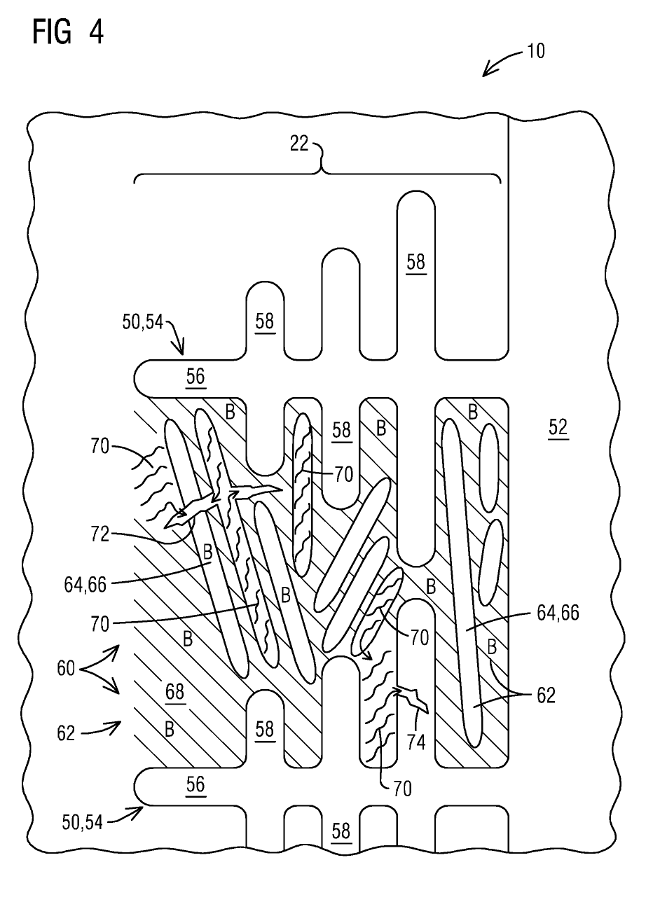

In FIG. 4 an interdendritic region crack 72 and a dendritic crack 74 have formed during cooling. Incipiently melted material 70 proximate the respective cracks 72, 74 can flow into the cracks 72, 74. This flow may be aided by a vacuum created in the cracks 72, 74 when the cracks 72, 74 form. The incipiently melted material 70 may flow into some or all of a respective volume of each crack 72, 74, thereby healing the cracks 72, 74.

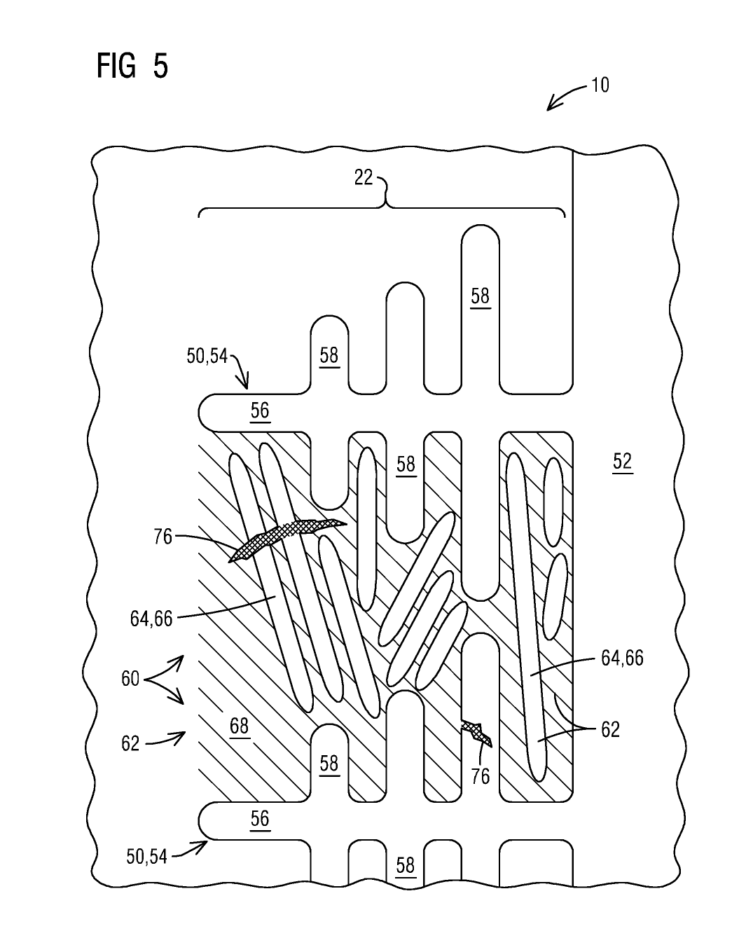

FIG. 5 shows the interdendritic region 60 after all materials have solidified, including healed cracks 76 filled with solidified incipiently melted material. During this process, and even thereafter at elevated temperatures, the boron continues to diffuse over time such that its suppressive and palliative effect ceases. The regions of differing chemical composition then return to their respective unsuppressed melting temperatures. The rate of this diffusion can be accelerated by a conventional post weld heat treatment (PWHT).

From the foregoing it can be seen that using an incipient melt facilitator, such as boron, can heal cracks during a welding process for a material such as a difficult to weld superalloy. This increases production yield previously lowered by weld induced cracks. Advantageously, the application of a boron paste directly onto the weld joint allows the use of base metal equivalent weld filler materials. Borax or other forms of boron are inexpensive, such as about $2/pound as compared to perhaps $50/pound for typical weld grade flux materials.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

The invention claimed is:

1. A method, comprising:
forming a melt pool on a superalloy substrate;
incorporating an incipient melt facilitator comprising at least 99 weight percent boron into the melt pool.

2. The method of claim 1, further comprising directing a stream of the incipient melt facilitator into the melt pool.

3. The method of claim 1, further comprising preplacing the incipient melt facilitator on the superalloy substrate where the melt pool is formed.

4. The method of claim 3, wherein the incipient melt facilitator comprises a paste.

5. The method of claim 4, further comprising applying the paste in a thickness in the range of (0.005″-0.020″).

6. The method of claim 1, wherein the boron comprises Na₂B₄O₇.

7. The method of claim 1, wherein the boron comprises an amorphous allotrope of boron.

8. The method of claim 1, further comprising solidifying the melt pool into a weld, and incorporating all of the boron into at least one of the weld and the superalloy substrate.

9. The method of claim 1, further comprising protecting the melt pool with an inert atmosphere and solidifying the melt pool into a weld that is free of slag.

10. The method of claim 1, further comprising solidifying the melt pool into a weld and heat treating the superalloy substrate and the weld to reduce a presence of incipient melting in the heat affected zone and the weld caused by the incipient melt facilitator.

11. A method, comprising:
covering a surface of a superalloy substrate with a paste comprising at least 99 weight percent boron;
heating the boron covered surface to form a melt pool comprising the boron;
controlling heating parameters to cause the boron to induced incipient melting in a heat affected zone surrounding the melt pool; and
controlling the heating parameters to ensure incipiently melted material in the heat affected zone remains in a liquid state during conditions known to cause heating-related cracking in the heat affected zone.

12. The method of claim 11, wherein the boron comprises Na₂B₄O₇.

13. The method of claim 11, further comprising protecting the melt pool with an inert atmosphere and solidifying the melt pool into a weld that is free of slag.

14. The method of claim 11, further comprising solidifying the melt pool into a weld and heat treating the superalloy substrate and the weld to reduce a presence of boron in the heat affected zone and the weld caused by the boron.

15. A method, comprising:
heating a superalloy substrate to form a melt pool;
incorporating an incipient melt facilitator comprising at least 99 weight percent boron into the melt pool;
controlling heating parameters to cause boron-induced incipient melting in at least one of the melt pool and a heat affected zone surrounding the melt pool; and
controlling the heating parameters to ensure incipiently melted material remains in a liquid state during conditions known to cause solidification cracking.

16. The method of claim 15, wherein the boron comprises Na₂B₄O₇.

17. The method of claim 15, further comprising preplacing the incipient melt facilitator on the superalloy substrate in a paste form where the melt pool is formed.

18. The method of claim 15, further comprising protecting the melt pool with an inert atmosphere and solidifying the melt pool into a weld that is free of slag.

19. The method of claim 15, further comprising solidifying the melt pool into a weld and heat treating the superalloy substrate and the weld to reduce a presence of incipient melting in the heat affected zone and the weld caused by the incipient melt facilitator.
